(19) United States
(12) Patent Application Publication
(10) Pub. No.: US 2026/0038152 A1
(43) Pub. Date: Feb. 5, 2026

(54) METHOD, APPARATUS AND DEVICE AND STORAGE MEDIUM FOR INTERPUPILLARY DISTANCE MEASUREMENT

(71) Applicant: Beijing Zitiao Network Technology Co., Ltd., Haidian District, Beijing (CN)

(72) Inventors: Xiang Long, Beijing (CN); Liying Chi, Beijing (CN); Chao Long, Beijing (CN)

(21) Appl. No.: 19/101,017

(22) PCT Filed: Nov. 15, 2023
(86) PCT No.: PCT/CN2023/131878

§ 371 Date: Feb. 4, 2025

(30) Foreign Application Priority Data
Nov. 18, 2022 (CN) 202211449421.3

(51) Int. Cl. G06T 7/80; G02B 27/00; G02B 27/01

(52) U.S. Cl. CPC G06T 7/80; G02B 27/0093; G02B 27/0172; G02B 2027/0138; G02B 2027/014; G06T 2207/10016; G06T 2207/30041

(57) ABSTRACT

Embodiments of the disclosure provides a scheme for interpupillary distance measurement, in particular to a method, an apparatus, an equipment, a storage medium for interpupillary distance measurement. According to embodiments described herein, during the interpupillary distance measurement, the control unit moves the two cameras from their respective initial positions to their respective end positions, and during the moving process, the two cameras are controlled to capture the left-eye image and the right-eye image, respectively. Further, the control unit determines corresponding calibration parameters for obtaining the interpupillary distance, and obtains the interpupillary distance of the user based on the corresponding calibration parameters and the captured images.

This application claims the benefit of Chinese Patent Application No. 202211449421.3 entitled “METHOD, APPARATUS AND DEVICE AND STORAGE MEDIUM FOR INTERPUPILLARY DISTANCE MEASUREMENT” filed on Nov. 18, 2022, the entire content of which is incorporated herein by reference.

### FIELD

Example embodiments of the present disclosure relate generally to measurement techniques, and more particularly, to a method, an apparatus, a device, and a computer-readable storage media for interpupillary distance measurement.

### BACKGROUND

The interpupillary distance refers to the distance between the pupils of the two eyes. When individuals wear wearable devices such as glasses, virtual reality helmets and the like, if the wearable device cannot match the user's interpupillary distance, it can cause discomfort for the user and diminish visual performance. Therefore, rapidly and accurately obtaining the user's interpupillary distance when using wearable devices is one of the key technologies for enhancing user experience.

### SUMMARY

In a first aspect of the present disclosure, a method for interpupillary distance measurement is provided. The method comprises: setting a first camera and a second camera at a first initial position and a second initial position, respectively, the first camera being configured to capture an image of a left eye of a user and associated with a first set of light sources, the second camera being configured to capture an image of a right eye of the user and associated with a second set of light sources; during a process of moving the first camera and the second camera respectively to a first end position and a second end position, controlling the first camera and the second camera to capture a first set of images of the left eye and a second set of images of the right eye of the user, respectively; obtaining a first set of parameters of the first camera and the first set of light sources corresponding to the first set of images and a second set of parameters of the second camera and the second set of light sources corresponding to the second set of images; and obtaining an interpupillary distance of the user based at least in part on the first set of images, the first set of parameters, the second set of images, and the second set of parameters.

In a second aspect of the present disclosure, an apparatus for interpupillary distance measurement is provided. The apparatus comprises: a position control module configured to set a first camera and a second camera at a first initial position and a second initial position, respectively, wherein the first camera is configured to capture an image of a left eye of a user and is associated with a first set of light sources, and the second camera is configured to capture an image of a right eye of the user and is associated with a second set of light sources; a camera control module configured to control the first camera and the second camera to capture a first set of images of the left eye and a second set of images of the right eye of the user, respectively, during a process of moving the first camera and the second camera respectively to a first end position and a second end position; a parameter obtaining module configured to obtain a first set of parameters of the first camera and the first set of light sources corresponding to the first set of images and a second set of parameters of the second camera and the second set of light sources corresponding to the second set of images; and an interpupillary distance measurement module configured to obtain an interpupillary distance of the user based at least in part on the first set of images, the first set of parameters, the second set of images, and the second set of parameters.

In a third aspect of the present disclosure, an electronic device is provided. The electronic device comprises: a first camera configured to capture an image of a left eye of a user; a second camera configured to capture an image of a right eye of the user; a first set of light sources associated with the first camera; a second set of light sources associated with the second camera; a control unit configured to perform the method according to the first aspect.

In a fourth aspect of the present disclosure, a computer-readable storage medium is provided. The computer-readable storage medium having a computer program stored thereon, and the computer program is executable by the processor to perform the method according to the first aspect of the present disclosure.

It should be understood that the content described in the content part of the present disclosure is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of the various implementations of the present disclosure will become more apparent from the following detailed description taken in conjunction with the accompanying drawings. In the drawings, the same or similar reference signs refer to the same or similar elements, wherein:

FIG. 1 shows a block diagram of an electronic device for interpupillary distance measurement according to some embodiments of the present disclosure;

FIG. 2 shows a flowchart of a method for interpupillary distance measurement according to some embodiments of the present disclosure;

FIG. 3 shows a schematic block diagram of adjusting positions of cameras according to some embodiments of the present disclosure;

FIG. 4 shows a flowchart of a method for obtaining a first set of parameters and a second set of parameters according to some embodiments of the present disclosure;

FIG. 5 shows a block diagram of an apparatus for interpupillary distance measurement according to some embodiments of the present disclosure; and

FIG. 6 shows a block diagram of an electronic device that can be used to implement some embodiments of the present disclosure.

### DETAILED DESCRIPTION

Embodiments of the present disclosure will be described in more detail below with reference to the accompanying drawings. While some embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

In the description of the embodiments of the present disclosure, the terms “comprising” and the like should be understood to include “comprising but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below.

The term “in response to” means that a corresponding event occurs or condition is satisfied. It will be appreciated that the timing of execution of subsequent actions performed in response to the event or condition is not necessarily strongly correlated with the time at which the event occurs or the condition is satisfied. In some cases, subsequent actions may be performed immediately when an event occurs or a condition holds; in other cases, subsequent actions may also be performed after a period of time after an event occurs or a condition holds.

In the description of embodiments of the present disclosure, the term “set” denotes a collection of one or more elements. As an example, a “set of images” should be understood as one or more images, a “set of parameters” should be understood as one or more parameters. In other words, the term “set” as used in embodiments of the present disclosure is not limited in terms of the number of elements it contains.

It may be understood that the data involved in the technical solution (including but not limited to the data itself, the obtaining or use of the data) should follow the requirements of the corresponding laws and regulations and related regulations.

It can be understood that, before the technical solutions disclosed in embodiments of the present disclosure are used, users should be informed of the types, the usage scope, the usage scenario and the like of personal information related to the present disclosure and obtain user authorization in an appropriate manner according to the relevant laws and regulations.

For example, in response to receiving an active request from a user, prompt information is sent to the user to explicitly prompt the user that the requested operation will need to obtain and use personal information of the user, so that the user may autonomously select whether to provide personal information to software or hardware executing the operation of the technical solution of the present disclosure according to the prompt information.

As an optional but non-limiting implementation, in response to receiving an active request of the user, a manner of sending prompt information to the user may be, for example, a pop-up window, and prompt information may be presented in a text manner in the pop-up window. In addition, the pop-up window may further carry a selection control for the user to select “agree” or “disagree” regarding providing personal information to the electronic device.

It may be understood that the foregoing notification and obtaining a user authorization process are merely illustrative, and do not constitute a limitation on implementations of the present disclosure, and other manners of meeting related laws and regulations may also be applied to implementations of the present disclosure.

As discussed above, quickly and accurately obtaining a user's interpupillary distance when using a wearable device is one of the key technologies that improve user experience. Conventional interpupillary distance measurement techniques require gaze estimation and eye position estimation and support interpupillary distance measurement using a single fixed camera and multiple fixed cameras.

When using a single fixed camera for interpupillary distance measurement, gaze estimation and eyeball position estimation rely on the constructed eye model. However, the eyeball belongs to one of the biological features of the user, so the eyeballs of different users are different. Therefore, when the physiological characteristic of a user's eyeball is larger than the constructed eyeball model, the error of the interpupillary distance measurement result is large. Further, when the interpupillary distance measurement is performed by using a single fixed camera, the camera's shooting direction is required to be perpendicular to a connection line of the two eyes, so as to reduce the influence of the depth estimation error on the interpupillary distance measurement result. However, adjusting the camera's shooting direction usually requires adding an optical element such as a hot mirror, and the introduction of an optical element such as a hot mirror increases the hardware cost and design complexity of the interpupillary distance measurement device.

Compared with a single fixed camera, using multiple fixed cameras for interpupillary distance measurement improves the accuracy of the interpupillary distance measurement, but incurs relatively higher hardware cost.

According to embodiments of the present disclosure, an interpupillary distance measurement solution based on a mobile camera is provided. According to various embodiments of the present disclosure, during the interpupillary distance measurement process, the control unit moves the two cameras from their respective initial positions to respective end positions, and during the moving process, the two cameras are controlled to shoot left-eye images and right-eye images, respectively. The control unit further determines a respective calibration parameter for obtaining the interpupillary distance, and obtains the user's interpupillary distance based on the corresponding calibration parameters and the captured images. In this way, the accuracy of interpupillary distance measurement is improved, and the hardware cost of interpupillary distance measurement is reduced. Example embodiments of the present disclosure are described below with reference to the accompanying drawings.

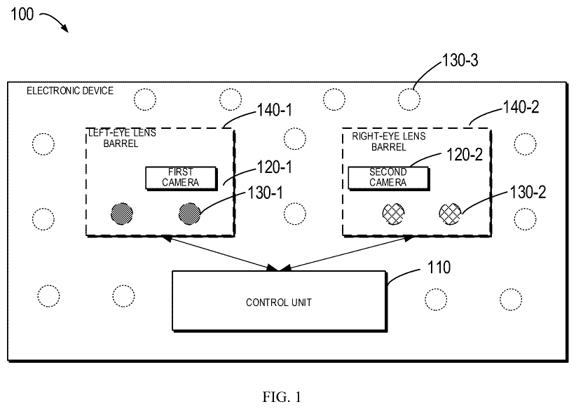

FIG. 1 shows a block diagram of an electronic device 100 for interpupillary distance measurement according to some embodiments of the present disclosure. As shown in FIG. 1, the electronic device 100 includes a first camera 120-1 configured to capture a left-eye image of a user, and a second camera 120-2 configured to capture a right-eye image of the user. For ease of discussion, the first camera 120-1 and the second camera 120-2 may be collectively referred to as a camera 120.

In some embodiments, to facilitate capturing the left-eye image and the right-eye image, the camera 120 may be arranged on the electronic device 110 in a tilted manner.

In some embodiments, to increase the accuracy of interpupillary distance measurement, multiple cameras may be configured to capture a left-eye image, and correspondingly, multiple cameras may be configured to capture a right-eye image.

In some embodiments, the electronic device 100 includes a movable assembly on which the first camera 120-1 and the second camera 120-2 are disposed. In this way, different from a fixed camera in the conventional technology, the camera 120 according to various embodiments of the present disclosure may be moved within the electronic device 110 to capture a plurality of left-eye images and right-eye images.

As a specific embodiment, the electronic device 100 is a virtual reality device, the first camera 120-1 is set on the left-eye lens barrel 140-1 of the virtual reality device, and the second camera 120-2 is set on the right-eye lens barrel 140-2 of the virtual reality device (for ease of discussion, the left-eye lens barrel 140-1 and the right-eye lens barrel 140-2 may be collectively referred to as the lens barrel 140). Further, the left-eye lens barrel 140-1 and the right-eye lens barrel 140-2 are arranged on a slide rail. In this way, the first camera 120-1 and the second camera 120-2 may move (i.e., translate) with the left-eye barrel 140-1 and the right-eye barrel 140-2 on the track.

Further, in this specific embodiment, the slide rail may be marked with a corresponding scale, and when the first camera 120-1 and the second camera 120-2 move on the slide rail with the left-eye lens barrel 140-1 and the right-eye lens barrel 140-2, the positions of the left-eye lens barrel 140-1/the first camera 120-1 and the right-eye lens barrel 140-2/the second camera 120-2 may be identified by the scale of the slide rail.

In some embodiments, the position information of the first camera 120-1 and the second camera 120-2 of the right-eye lens barrel 140-1/may be obtained by a sensor.

Alternatively, in some embodiments, the position information of the left-eye barrel 140-1/first camera 120-1 and the right-eye barrel 140-2/second camera 120-2 may be determined based on the respective one or more parameters. For example, in the case where the initial position is known, the position information of the left-eye lens barrel 140-1/the first camera 120-1 and the right-eye lens barrel 140-2/the second camera 120-2 may be determined based on parameters such as movement trajectories and/or movement speeds of the left-eye lens barrel 140-1/the first camera 120-1 and the right-eye lens barrel 140-2/the second camera 120-2 on the slide rail.

It should be understood that the above embodiments for identifying the position information are merely illustrative, and in other embodiments, the position information of the left-eye lens barrel 140-1/the first camera 120-1 and the right-eye lens barrel 140-2/the second camera 120-2 may be identified in other manners. The present disclosure is not limited in this respect.

As shown in FIG. 1, the electronic device 100 further includes a control unit 110. In some embodiments, the control unit 100 may execute corresponding logic, operations, and may communicate with other components of the electronic device 100 to exchange control messages and data.

In a specific embodiment in which the electronic device 100 is a virtual reality device, the control unit 100 may control the left-eye lens barrel 140-1 and the right-eye lens barrel 140-2 to move on the sliding rail. In this way, the control unit 110 may control the position of the first camera 120-1 by controlling the position of the left-eye lens barrel 140-1, and correspondingly control the position of the second camera 120-2 by controlling the position of the right-eye lens barrel 140-2.

In some embodiments, the electronic device 100 includes at least one light source. Further, the at least one light source may be a movable light source or a non-movable light source. In some embodiments, the movable light source is set on a movable component of the electronic device 100, and the non-removable light source is set on a non-removable component of the electronic device 100.

In a specific embodiment where the electronic device 100 is a virtual reality device, movable light sources may be disposed on the left-eye lens barrel 140-1 and the right-eye lens barrel 140-2. In the specific embodiment of FIG. 1, the movable light source 130-1 is disposed on the left-eye lens barrel 140-1, the movable light source 130-2 is disposed on the right-eye lens barrel 140-2, and the non-movable light source is disposed on the back plates of the left-eye lens barrel 140-1 and the right-eye lens barrel 140-2 (the light source 130-3 as shown in FIG. 1). For ease of discussion, the light sources 130-1, 130-2 and light source 130-3 may be collectively referred to as light sources 130.

In some embodiments, a first set of light sources of the at least one light source is associated with a first camera 120-1 and a second set of light sources of the at least one light source is associated with a second camera 120-2.

In some embodiments, the association relationship between the camera 120 and the light source may be predefined. For example, in a factory setting of the electronic device 100, the first set of light sources are pre-associated with the first camera 120-1, and the second set of light sources are pre-associated with the second camera 120-2.

Alternatively or additionally, in some embodiments, the association relationship between the camera 120 and the light source may be associated with a positional relationship between the camera 120 and the light source. As an example embodiment, the camera 120 and the light source assembled on the same movable component, such as the lens barrel 140, may be associated with each other. In another example embodiment, the camera 120 is associated with the light source when the distance between the camera 120 and the light source is less than a threshold distance.

Alternatively or additionally, in some embodiments, the association relationship between the camera 120 and the light source may be associated with a specific function. As an example embodiment, when the light source and the first camera 120-1 cooperatively capture the user's left eye image, the light source and the first camera 120-1 are associated with each other. Accordingly, when the light source and the second camera 120-2 cooperatively capture the user's right eye image, the light source and the second camera 120-2 are associated with each other.

In short, the association relationship between the camera 120 and the light source may be predefined or configured based on a certain rule. The present disclosure is not limited in this respect.

In some embodiments, the number of light sources associated with the first camera 120-1/and the second camera 120-2 is 1. In this way, the hardware cost benefit of the device will be optimized. Alternatively, in other embodiments, the number of light sources associated with the first camera 120-1/the second camera 120-2 is greater than 1. In this way, the accuracy of the interpupillary distance measurement result will be improved.

In some embodiments, the light source 130 is a light emitting diode (LED). In addition, due to the lower external interference from the infrared band compared with other bands, in some embodiments, the camera 120 is an infrared camera, and the light source is an infrared LED. In this way, the accuracy of the results of the interpupillary distance measurement will be improved. Alternatively, in some other embodiments, the camera 120 and the light source 130 may also be configured to operate in other bands.

In some embodiments, parameters of the camera 120 and the light source 130 may be calibrated in advance. Example calibration parameters include, but are not limited to, internal parameters of the camera 120, external parameters of the non-movable light source 130 (such as the light source 130-3) relative to the device coordinate system, external parameters of the movable light source 130 (such as the light sources 130-1 and 130-2) relative to the camera 130 on the respective lens barrel 140. An example of a coordinate system of the device is an inertial measurement unit (IMU).

In some embodiments, some calibration parameters of the camera 120 and the light source 130 are associated with a specific position (referred to simply as a “calibration parameter” in this disclosure). As a specific embodiment, the distance between the left-eye lens barrel 140-1 and the right-eye lens barrel 140-2 is adjusted to a first predetermined distance (such as the longest distance, also referred to as the farthest lens barrel position), and the calibration parameters of the camera 120 and the light source 130 and the position (such as the scale of the slide rail) of the lens barrel 140/camera 120 at this time are recorded. Further, the distance between the left-eye lens barrel 140-1 and the right-eye lens barrel 140-2 is adjusted to a second predetermined distance (such as the shortest distance, also referred to as the shortest lens barrel position), and the respective calibration parameters of the camera 120 and the light source 130 are recorded and the position (such as the scale of the slide rail) of the lens barrel 140/camera 120 is recorded.

In some embodiments, the calibration parameters of the camera 120 and the light source 130 corresponding to the first predetermined distance and the second predetermined distance may be calibrated and recorded as factory parameters.

It should be understood that FIG. 1 shows only an example of an electronic device 100 for interpupillary distance measurement. In other words, the number of components shown in FIG. 1 and their association relationship may be changed according to a specific application scenario. Embodiments of the present disclosure are not limited in this respect.

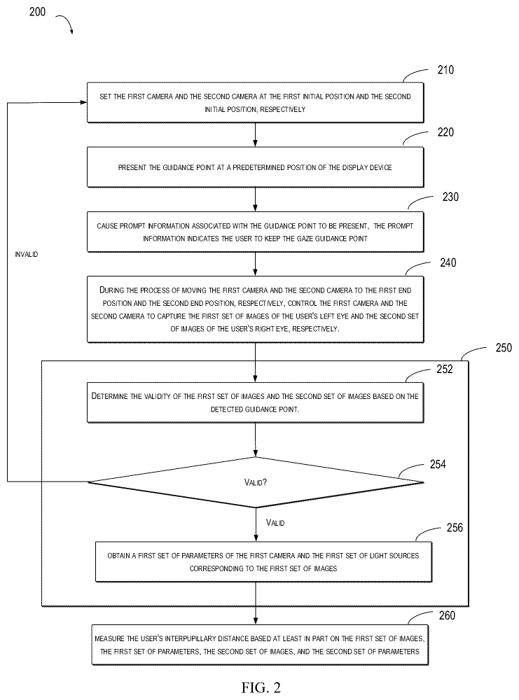

FIG. 2 depicts a flowchart for a method 200 for interpupillary distance measurement according to some embodiments of the present disclosure. For ease of discussion, the method 200 is discussed with reference to the electronic device 100 of FIG. 1. The method 200 may be performed by the control unit 110 in FIG. 1.

At block 210, the control unit 110 sets the first camera 120-1 and the second camera 120-2 at the first initial position and the second initial position, respectively.

In a specific embodiment, the first initial position and the second initial position correspond to the longest distance between the left-eye lens barrel 140-1 and the right-eye lens barrel 140-2. Alternatively, in yet another particular embodiment, the first initial position and the second initial position correspond to the shortest distance between the left- eye barrel 140-1 and the right-eye barrel 140-2. It should be understood that in other specific embodiments, the first initial position and the second initial position may correspond to any distance between the left-eye lens barrel 140-1 and the right-eye lens barrel 140-2. Embodiments of the present disclosure are not limited in this respect.

In some embodiments, the first camera 120-1 is configured to capture an image of a user's left eye and is associated with a first set of light sources, and the second camera 120-2 is configured to take an image of a user's right eye and is associated with a second set of light sources.

In some implementations described next, the light source 130-1 arranged on the left-eye lens barrel 140-1 is taken as an example of the first set of light sources, and the light source 130-2 arranged on the right-eye lens barrel 140-2 is taken as an example of the second set of light sources. In this case, the light source 130-1 is also referred to as a first set of light sources 130-1, and the light source 130-2 is also referred to as a second set of light sources 130-2.

It should be understood that the association relationship between the light source 130 and the camera 120 is merely an example. In other embodiments, the relationship between light source 130 and the camera 120 may be configured arbitrarily based on actual needs. Various embodiments of the present disclosure are not limited in this respect.

At block 220, the control unit 110 controls the first camera 120-1 to move from the first initial position to the first end position, and controls the first camera 120-1 to capture the user's left eye to obtain the first set of images. Correspondingly, the control unit 110 controls the second camera 120-2 to move from the second initial position to the second end position, and controls the second camera 120-2 to capture the user's right eye to obtain the second set of images.

That is, during the process of controlling the first camera 120-1 and the second camera 120-2 to move from the first initial position and the second initial position to the first end position and the second end position, respectively, the control unit 110 controls the first camera 120-1 and the second camera 120-2 to capture the first set of images of the left eye and the second set of images of the right eye of the user, respectively. It should be understood that the first initial position, the second initial position, the first end position, and the second end position may or may not belong to a part of the movement process of the camera 120. In other words, the present disclosure is not limited in how to define an initial position and/or an end position of the movement process of the camera 120.

In some embodiments, the first set of images includes at least a first image captured at a first time point and a second image captured at a second time point, and the second set of images includes at least a third image captured at a third time point and a fourth image captured at a fourth time point. In other words, the first/second set of images includes at least images captured at two different time points. In this way, it may be ensured that the number of images captured may meet the minimum number of images required to determine the interpupillary distance.

In some embodiments, the first time point is different from the third time point, and the second time point is different from the fourth time point. In this way, the movement processes of the first camera 120-1 and the second camera 120-2 may be controlled independently such that the interpupillary distance measurement process will be more flexible. Alternatively, in some other embodiments, the first time point is the same as the third time point, and the second time point is the same as the fourth time point. In this way, the total duration required for interpupillary distance measurement will be shortened.

In a specific embodiment, the first initial position and the second initial position correspond to the longest distance between the left-eye lens barrel 140-1 and the right-eye lens barrel 140-2, and at this time, the first end position and the second end position may correspond to the shortest distance between the left-eye lens barrel 140-1 and the right-eye lens barrel 140-2.

Alternatively, when the first initial position and the second initial position correspond to the shortest distance between the left-eye lens barrel 140-1 and the right-eye lens barrel 140-2, the first end position and the second end position may correspond to the longest distance between the left-eye lens barrel 140-1 and the right-eye lens barrel 140-2.

It should be understood that the first end position and the second end position in the above specific embodiment are merely examples, and should not be construed as any limitation on the present disclosure. In other embodiments, the first end position and the second end position may be set at any other position according to actual needs. Embodiments of the present disclosure are not limited in this respect.

In some embodiments, the first camera 120-1 and the second camera 120-2 are moved from the first initial position and the second initial position to the first end position and the second end position at a faster speed, e.g., within a half second. In this way, the probability of blinking and line of sight offset of the user during the shooting process is reduced.

In some embodiments, movement of the first camera 120-1 and the second camera 120-2 may be controlled independently. In other words, the movement initial time and/or the movement end time of the first camera 120-1 and the second camera 120-2 may be different. In this way, the interpupillary distance measurement process will be more flexible.

Alternatively or additionally, in some embodiments, movement of the first camera 120-1 and the second camera 120-2 may be collaboratively controlled, i.e., the camera 120-1 moves the initial time and the movement end time the same as the movement initial time and the movement end time of the camera 120-2. In this way, the total duration required for interpupillary distance measurement will be shortened.

In some embodiments, the first camera 120-1 and the second camera 120-2 capture the left-eye image and the right-eye image during movement of the camera 120 at a higher predetermined frame rate (e.g., greater than 60 FPS). In this way, the number of images captured is increased, and correspondingly, the accuracy of the interpupillary distance measurement is improved.

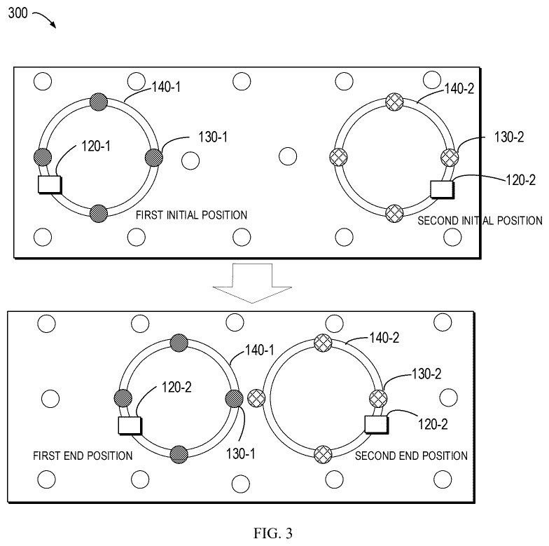

Movement of the camera position is better understood with reference to FIG. 3. FIG. 3 shows a schematic block diagram 300 of adjusting camera positions according to some embodiments of the present disclosure. In the specific embodiment of FIG. 3, the first initial position and the second initial position correspond to the longest distance between the left-eye barrel 140-1 and the right-eye barrel 140-1. The first end position and the second end position correspond to the shortest distance between the left-eye lens barrel 140-1 and the right-eye lens barrel 140-1.

In a specific embodiment where the electronic device is a virtual reality device, after the user wears the virtual reality device, the virtual reality device adjusts the left-eye lens barrel and the right-eye lens barrel to the farthest position (which may be the nearest position). Next, the VR device adjusts the left-eye lens barrel 140-1 and the right-eye lens barrel 140-2 from the farthest position to the nearest position. During the movement of the left-eye lens barrel 140-1 and the right-eye lens barrel 140-2, the first camera 120-1 and the second camera 120-2 respectively shoot the left eye and the right eye of the user at the at least two moments to obtain the first set of images and the second set of images.

At block 250, the control unit 110 obtains the respective parameters required to compute the interpupillary distance. In the specific embodiment of FIG. 2, at block 256, the control unit 110 obtains a first set of parameters of the first camera 120-1 and the first set of light sources 130-1 corresponding to the first set of images, and a second set of parameters of the second camera 120-2 and the second set of light sources 130-2 corresponding to the second set of images.

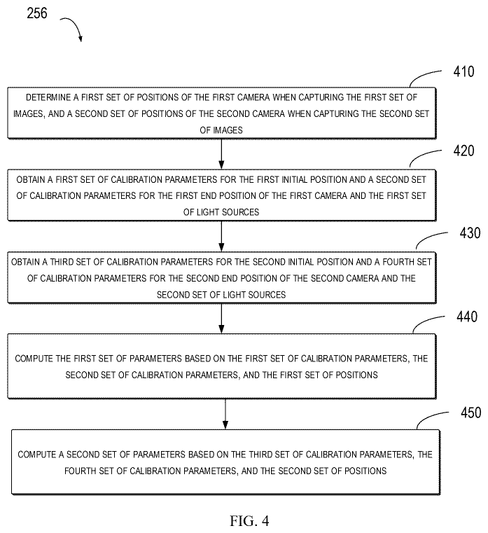

Next, the process of obtaining the first set of parameters and the second set of parameters will be described in detail with reference to FIG. 4. FIG. 4 shows a flowchart of a method 400 for obtaining a first set of parameters and a second set of parameters according to some embodiments of the present disclosure.

At block 410, the control unit 110 determines a first set of positions of the first camera 120-1 when capturing the first set of images, and a second set of positions of the second camera 120-2 when capturing the second set of images.

In a specific embodiment, during the process of moving the first camera 120-1 and the second camera 120-2 from the first initial position and the second initial position to the first end position and the second end position, the control unit 110 controls the first camera 120-1 and the second camera 120-2 to capture images of the left eye and the right eye, respectively, and simultaneously records the position (such as the coordinates of the slide rail, that is, the position of the camera 120) of the lens barrel 140 at each shooting moment.

At block 420, the control unit 110 obtains a first set of calibration parameters for the first position and a second set of calibration parameters for the second position of the first camera 120-1 and the first set of light sources 130-1.

At block 430, the control unit 110 obtains a third set of calibration parameters for the third position and a fourth set of calibration parameters for the fourth position of the second camera 120-2 and the second set of light sources 130-2.

In some embodiments, the first position is a first initial position, the second position is a first end position, the third position is a second initial position, and the fourth position is a second end position.

At block 440, the control unit 110 computes the first set of parameters based on the first set of calibration parameters, the second set of calibration parameters, and the first set of positions.

At block 450, the control unit 110 computes a second set of parameters based on the third set of calibration parameters, the fourth set of calibration parameters, and the second set of positions.

In some embodiments, the calibration parameters include, but are not limited to, internal parameters of the camera 120, external parameters of the non-movable light source 130 (such as the light source 130-3) relative to the device coordinate system, external parameters of the movable light source 130 (such as the light sources 130-1 and 130-2) relative to the camera 130 on the respective lens barrel 140.

In some embodiments, the first set of calibration parameters, the second set of calibration parameters, the third set of calibration parameters, and the fourth set of calibration parameters are known calibration parameters (e.g., recorded in factory settings). As a specific embodiment, the known calibration parameters include a calibration parameter when a distance between the left-eye lens barrel 140-1 and the right-eye lens barrel 140-2 is a first predetermined distance (such as a longest distance), that is, a first set of calibration parameters and a third set of calibration parameters corresponding to the first initial position of the first camera 120-1 and the second initial position of the second camera 120-2.

Correspondingly, the known calibration parameters further include a calibration parameter when the distance between the left-eye lens barrel 140-1 and the right-eye lens barrel 140-2 is a second predetermined distance (such as a shortest distance), that is, a second set of calibration parameters and a fourth set of calibration parameters corresponding to the first end position of the first camera 120-1 and the second end position of the second camera 120-2.

As discussed above, during the process of moving the first camera 120-1 and the second camera 120-2 from the first initial position and the second initial position to the first end position and the second end position, the control unit 110 simultaneously records the position (such as the coordinates of the sliding rail) of the lens barrel 140 at each shooting moment. Since the movement of the lens barrel 140 on the slide rail is translational movement, the calibration parameters of the camera 120 and the light source 130 at other shooting moments can be obtained through interpolation operation based on the known first set of calibration parameters, the second set of calibration parameters, the third set of calibration parameters and the fourth set of calibration parameters as an computing basis. Thus, a first set of parameters is computed based on the first set of calibration parameters, the second set of calibration parameters, and the first set of positions, and a second set of parameters is computed based on the third set of calibration parameters, the fourth set of calibration parameters, and the second set of positions.

Specifically, in some embodiments, for the position of each lens barrel 14-0 (i.e., the position of the camera 120), the external parameters of the camera 120 are interpolated based on the known calibration parameters to obtain the external parameters of the camera at this position. For the movable light source 130 (such as the light sources 130-1 and 130-2), if the external parameters are originally calibrated with respect to the camera 120 on the respective lens barrel 140, the external parameters of the camera 120 on the respective lens barrels 140 need to be converted into external parameters relative to the device coordinate system.

In this way, the control unit 110 may obtain a first set of parameters and a second set of parameters for computing the interpupillary distance. It should be understood that the foregoing process of obtaining the first set of parameters and the second set of parameters is merely illustrative, and should not be construed as limiting embodiments of the present disclosure. In other implementations, the first set of parameters and the second set of parameters may also be obtained in other manners, including but not limited to real-time measurement.

With continued reference to FIG. 2, at block 260, the control unit 110 obtains the user's interpupillary distance based at least in part on the first set of images, the first set of parameters, the second set of images, and the second set of parameters.

According to some embodiments of the present disclosure, the time when the camera 120 moves from the initial position to the end position is relatively short, so that the spatial position of the eyeball may be considered unchanged. In this case, images captured by the same camera 120 at different times may be equivalent to an eyeball image captured simultaneously by a plurality of cameras at different positions.

In this case, the interpupillary distance of the user may be measured by any multi-view camera-based algorithm. One example algorithm is the pupil corneal reflection method. Another example algorithm is a triangle reconstruction algorithm. It should be understood that the above algorithm is by way of example only, and various embodiments of the present disclosure may use any existing or future proposed multi-view camera-based algorithm to measure the interpupillary distance of the user. Various embodiments of the present disclosure are not limited in this respect.

In some embodiments, in order to improve the accuracy of interpupillary distance measurements, the user may also be directed at a guidance point during the measurement. As shown in FIG. 2, at block 220, the control unit 110 presents the guidance point at a predetermined position of the display device. Further, in block 230, the control unit 110 provides prompt information associated with the guidance point to the user, and the prompt information indicates the user to keep the gaze guidance point. The prompt information may be provided to the user in any manner such as text and voice. The present disclosure is not limited in the manner of providing the prompt information.

In a specific embodiment in which the electronic device 110 is a virtual reality device, a guidance point may be displayed in the virtual reality interface, and the user may be prompted to gaze at the guidance point and remain stationary.

In addition, the user may have a blink or line-of-sight offset during the measurement process, and at this time, the user's interpupillary distance cannot be obtained based on the captured image. That is, invalid first group images and second group images are generated in the measurement. In view of this, in some embodiments, the validity of the captured image may be detected.

As shown in FIG. 3, at block 252, the control unit 110 detects validity of the first set of images and the second set of images. At block 254, the control unit 110 determines whether the first set of images and the second set of images are valid, and if the first set of images and the second set of images are valid, execute block 256, and if the first set of images and the second set of images are valid, return to execute block 210.

In some embodiments, the validity detection is performed for all images of the first set of images and the second set of images.

Alternatively, in some embodiments, in order to improve the detection efficiency, partial images in the first set of images and partial images in the second set of images may be selected to perform detection of validity.

In some embodiments, the first set of images and the second set of images are determined to be invalid if at least part of the first set of images and/or at least part of the second set of images show that the user is blinking or line-of-sight offset during the measurement.

In some embodiments, the control unit 110 detects the left-eye pupil and the right-eye pupil of the user in at least part of the first set of images and at least part of the second set of images according to the pupil detection model. If the left-eye pupil is not detected in at least part of the first set of images (or the right-eye pupil is not detected in at least part of the second set of images), the user may be estimated to blink, and at this time, it is determined that the first set of images and the second set of images are invalid.

As a specific example, if a left-eye pupil is not detected in any image of the first set of images (or a right-eye pupil is not detected in any image of the second set of images), it is determined that the first set of images and the second set of images are invalid.

If the left-eye pupil is detected in at least part of the first set of images, the relative position change of the position of the left-eye pupil in at least part of the first set of images is detected. Accordingly, if the right-eye pupil is detected in at least part of the first set of images, the relative position change of the position of the right-eye pupil in at least part of the second set of images is detected. If the position of the pupil of the left/right eye changes, the gaze of the user is estimated to shift, and at this time, it is determined that the first set of images and the second set of images are invalid; otherwise, it is determined that the first set of images and the second set of images are valid.

In some embodiments, detecting the relative position change of the position of the left/right-eye pupil in the at least part of the first/second set of images includes detecting a position change of the position of the left/right-eye pupil in each pair of adjacent images in at least part of the first/second set of images.

Alternatively, in some embodiments, detecting the relative position change of the position of the left/right-eye pupil in at least part of the first/second set of images includes detecting a position change the position of the left/right-eye pupil in at least one pair of adjacent images in at least part of the first/second set of images.

In some embodiments, for all input images or selected part of input images, the pupil detection model is used to detect the ellipse of the pupil, if there are two adjacent images, and the center displacement of the pupil ellipse of the two adjacent images is greater than the first predetermined number of pixels (such as 2 pixels), it is determined that the first set of images and the second set of images are invalid. In some embodiments, the first predetermined number of pixels is associated with at least one of a resolution of the camera 120 and a distance between the camera 120 and a left/right eye of the user.

According to various embodiments of the present disclosure, a method of interpupillary distance measurement based on a movable camera is provided. In an embodiment of the present disclosure, the effect of the multi-view camera is achieved by moving the position of a single camera. In this way, the hardware cost required for interpupillary distance measurement is reduced, and the precision of the interpupillary distance measurement is improved.

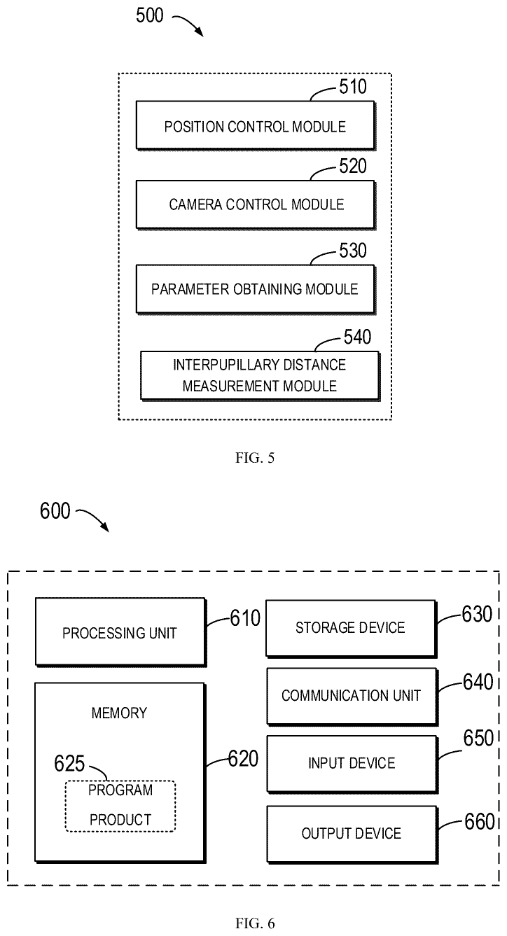

FIG. 5 shows a block diagram of an apparatus 500 for interpupillary distance measurement according to some embodiments of the present disclosure. The apparatus 500 may be implemented or included in the control unit 110. The various modules/components in the apparatus 500 may be implemented by hardware, software, firmware, or any combination thereof.

As shown, the apparatus 500 includes a position control module 510 configured to set the first camera 120-1 and the second camera 120-2 in a first initial position and a second initial position, respectively, the first camera 120-1 being configured to capture an image of a left eye of a user and being associated with a first set of light sources 130-1, the second camera 120-2 being configured to capture an image of a right eye of the user and associated with a second set of light sources 130-2.

The apparatus 500 further includes a camera control module 520 configured to control the first camera 120-1 and the second camera 120-2 to capture a first set of images of a left eye and a second set of images of a right eye of the user, respectively, during a process of moving the first camera 120-1 and the second camera 120-2 to a first end position and a second end position, respectively.

The apparatus 500 further includes a parameter obtaining module 530 configured to obtain a first set of parameters of the first camera 120-1 and the first set of light sources 130-1 corresponding to the first set of images, and a second set of parameters of the second camera 120-2 and the second set of light sources 130-2 corresponding to the second set of images.

The apparatus 500 further includes an interpupillary distance measurement module 540 configured to obtain an interpupillary distance of the user based at least in part on the first set of images, the first set of parameters, the second set of images, and the second set of parameters.

In some embodiments, the first set of images includes at least a first image captured at a first time point and a second image captured at a second time point, and the second set of images includes at least a third image captured at a third time point and a fourth image captured at a fourth time point.

In some embodiments, the parameter obtaining module 530 includes: a position determining module configured to determine a first set of positions of the first camera 120-1 when capturing the first set of images and a second set of positions of the second camera 120-2 when capturing the second set of images; a first calibration parameter obtaining module configured to obtain a first set of calibration parameters of the first camera 120-1 and the first set of light sources 130-1 for a first position and a second set of calibration parameters for a second position; a second calibration parameter obtaining module configured to obtain a third set of calibration parameters of the second camera 120-2 and the second set of light sources 130-2 for a third position and a fourth set of calibration parameters for a fourth position; a first parameter computing module configured to compute the first set of parameters based on the first set of calibration parameters, the second set of calibration parameters, and the first set of positions; and a second parameter computing module configured to compute the second set of parameters based on the third set of calibration parameters, the fourth set of calibration parameters, and the second set of positions.

In some embodiments, the first position is the first initial position, the second position is the first end position, the third position is the second initial position, and the fourth position is the second end position.

In some embodiments, the apparatus 500 further includes: a guidance point presentation module configured to cause the guidance point to be presented at a predetermined position of a display device; and a prompt module configured to provide prompt information associated with the guidance point to the user, wherein the prompt information indicates that the user keep gazing at the guidance point.

In some embodiments, the parameter obtaining module 530 includes: a validity detection module configured to detect validity of the first set of images and the second set of images; and a parameter acquisition submodule configured to acquire the first set of parameters and the second set of parameters in response to both the first set of images and the second set of images being detected as valid.

In some embodiments, the validity detection module comprises: a pupil detection module configured to respectively detect a left-eye pupil and a right-eye pupil of a user in at least part of the first set of images and at least part of the second set of images according to a pupil detection model; a left-eye position change detection module configured to detect a relative position change of a position of the left-eye pupil in the at least part of the first set of images in response to detecting the left-eye pupil in the at least part of the first set of images; and a right-eye position change detection module configured to detect a relative position change of a position of the right-eye pupil in the at least part of the second set of images in response to detecting the right-eye pupil in the at least part of the second set of images.

In some embodiments, the first camera 120-1 is set on a left-eye lens barrel 140-1 of a virtual reality device, the second camera 120-2 is set on a right-eye lens barrel 140-2 of the virtual reality device, wherein a position of the first camera 120-1 is controlled by controlling a position of the left-eye lens barrel 140-1, and a position of the second camera 120-2 is controlled by controlling a position of the right-eye lens barrel 140-2.

The units included in the apparatus 500 may be implemented in various manners, including software, hardware, firmware, or any combination thereof. In some embodiments, one or more units may be implemented using software and/or firmware, such as machine- executable instructions stored on a storage medium. In addition to or as an alternative to machine-executable instructions, some or all of the elements in the apparatus 500 may be implemented, at least in part, by one or more hardware logic components. By way of example and not limitation, example types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

FIG. 6 shows a block diagram of an electronic device 600 in which one or more embodiments of the present disclosure may be implemented. The electronic device 600 shown in FIG. 6 is merely exemplary and does not constitute any limitation on the functionality and scope of embodiments described herein.

As shown in FIG. 6, the electronic device/server 600 is in the form of a general-purpose electronic device. The components of the electronic device/server 600 may include, but are not limited to, one or more processors or processing units 610, a memory 620, a storage device 630, one or more communication units 640, one or more input devices 650, and one or more output devices 660. The processing unit 610 may be an actual or virtual processor and capable of performing various processes according to programs stored in the memory 620. In multiprocessor systems, multiple processing units execute computer-executable instructions in parallel to improve the parallel processing capability of the electronic device/server 600.

The electronic device/server 600 typically includes a plurality of computer storage media. Such media may be any available media accessible by the electronic device/server 600, including, but not limited to, volatile and non-volatile media, removable and non-removable media. The memory 620 may be volatile memory (e.g., registers, caches, random access memory (RAM)), non-volatile memory (e.g., read-only memory (ROM), electrically erasable programmable read-only memory (EEPROM), flash memory), or some combination thereof. The storage device 630 may be a removable or non-removable medium and may include a machine-readable medium, such as a flash drive, magnetic disk, or any other medium, which may be capable of storing information and/or data (e.g., training data for training) and may be accessed within the electronic device/server 600.

The electronic device/server 600 may further include additional removable/non-removable, volatile/non-volatile storage media. Although not shown in FIG. 6, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 620 may include a computer program product 625 having one or more program modules configured to perform various methods or actions of various embodiments of the present disclosure.

The communication unit 640 is configured to communicate with another electronic device through a communication medium. Additionally, the functionality of the components of the electronic device/server 600 may be implemented in a single computing cluster or multiple computing machines capable of communicating over a communication connection. Thus, the electronic device/server 600 may operate in a networked environment using logical connections with one or more other servers, network personal computers (PCs), or another network node.

The input device 650 may be one or more input devices such as a mouse, a keyboard, a trackball, or the like. The output device 660 may be one or more output devices, such as a display, a speaker, a printer, or the like. The electronic device/server 600 may also communicate with one or more external devices (not shown) as needed, external devices such as storage devices, display devices, etc., communicate with one or more devices that enable a user to interact with the electronic device/server 600, or communicate with any device (e.g., network card, modem, etc.) that enables the electronic device/server 600 to communicate with one or more other electronic devices. Such communication may be performed via an input/output (I/O) interface (not shown).

According to example implementations of the present disclosure, there is provided a computer-readable storage medium having one or more computer instructions stored thereon, wherein one or more computer instructions are executed by a processor to implement the method described above.

Aspects of the present disclosure are described herein with reference to flowcharts and/or block diagrams of methods, apparatuses (systems), and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may also be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the implementations disclosed herein.

1. A method for interpupillary distance measurement, comprising:
setting a first camera and a second camera at a first initial position and a second initial position, respectively, the first camera being configured to capture an image of a left eye of a user and associated with a first set of light sources, the second camera being configured to capture an image of a right eye of the user and associated with a second set of light sources;
during a process of moving the first camera and the second camera respectively to a first end position and a second end position, controlling the first camera and the second camera to capture a first set of images of the left eye and a second set of images of the right eye of the user, respectively;
obtaining a first set of parameters of the first camera and the first set of light sources corresponding to the first set of images and a second set of parameters of the second camera and the second set of light sources corresponding to the second set of images; and
obtaining an interpupillary distance of the user based at least in part on the first set of images, the first set of parameters, the second set of images, and the second set of parameters.

2. The method of claim 1, wherein the first set of images comprises at least a first image captured at a first time point and a second image captured at a second time point, and the second set of images comprises at least a third image captured at a third time point and a fourth image captured at a fourth time point.

3. The method of claim 1, wherein obtaining the first set of parameters and the second set of parameters comprises:
determining a first set of positions where the first camera is located when capturing the first set of images and a second set of positions where the second camera is located when capturing the second set of images;
obtaining a first set of calibration parameters of the first camera and the first set of light sources for a first position and a second set of calibration parameters for a second position;
obtaining a third set of calibration parameters of the second camera and the second set of light sources for a third position and a fourth set of calibration parameters for a fourth position;
computing the first set of parameters based on the first set of calibration parameters, the second set of calibration parameters, and the first set of positions; and
computing the second set of parameters based on the third set of calibration parameters, the fourth set of calibration parameters, and the second set of positions.

4. The method of claim 3, wherein the first position is the first initial position, the second position is the first end position, the third position is the second initial position, and the fourth position is the second end position.

5. The method of claim 1, further comprising:
causing a guidance point to be presented at a predetermined position of a display device; and
providing prompt information associated with the guidance point to the user, wherein the prompt information indicates the user to keep gazing at the guidance point.

6. The method of claim 1, wherein obtaining the first set of parameters and the second set of parameters comprises:
detecting validity of the first set of images and the second set of images; and
in response to both the first set of images and the second set of images being detected as valid, obtaining the first set of parameters and the second set of parameters.

7. The method of claim 6, wherein detecting validity of the first set of images and the second set of images comprises:
detecting a left-eye pupil and a right-eye pupil of the user in at least part of the first set of images and at least part of the second set of images respectively according to a pupil detection model;
in response to detecting the left-eye pupil in the at least part of the first set of images, detecting a relative position change of a position of the left-eye pupil in the at least part of the first set of images; and
in response to detecting the right-eye pupil in the at least part of the second set of images, detecting a relative position change of a position of the right-eye pupil in the at least part of the second set of images.

8. The method of claim 1, wherein the first camera is set on a left-eye lens barrel of a virtual reality device, and the second camera is set on a right-eye lens barrel of the virtual reality device,
wherein a position of the first camera is controlled by controlling a position of the left-eye lens barrel, and
wherein a position of the second camera is controlled by controlling a position of the right-eye lens barrel.

9-16. (canceled)

17. An electronic device comprising:
a first camera configured to capture an image of a left eye of a user;
a second camera configured to capture an image of a right eye of the user;
a first set of light sources associated with the first camera;
a second set of light sources associated with the second camera; and
a control unit configured to:
set the first camera and the second camera at a first initial position and a second initial position, respectively;
during a process of moving the first camera and the second camera respectively to a first end position and a second end position, control the first camera and the second camera to capture a first set of images of the left eye and a second set of images of the right eye of the user, respectively;
obtain a first set of parameters of the first camera and the first set of light sources corresponding to the first set of images and a second set of parameters of the second camera and the second set of light sources corresponding to the second set of images; and
obtain an interpupillary distance of the user based at least in part on the first set of images, the first set of parameters, the second set of images, and the second set of parameters.

18. The electronic device of claim 17, wherein the electronic device is a head-mounted display device.

19. A non-transitory_computer-readable storage medium having a computer program stored thereon, which when executed by a processor, implements:
setting a first camera and a second camera at a first initial position and a second initial position, respectively, the first camera being configured to capture an image of a left eye of a user and associated with a first set of light sources, the second camera being configured to capture an image of a right eye of the user and associated with a second set of light sources;
during a process of moving the first camera and the second camera respectively to a first end position and a second end position, controlling the first camera and the second camera to capture a first set of images of the left eye and a second set of images of the right eye of the user, respectively;
obtaining a first set of parameters of the first camera and the first set of light sources corresponding to the first set of images and a second set of parameters of the second camera and the second set of light sources corresponding to the second set of images; and
obtaining an interpupillary distance of the user based at least in part on the first set of images, the first set of parameters, the second set of images, and the second set of parameters

20. The electronic device of claim 17, wherein the first set of images comprises at least a first image captured at a first time point and a second image captured at a second time point, and the second set of images comprises at least a third image captured at a third time point and a fourth image captured at a fourth time point.

21. The electronic device of claim 17, wherein the control unit is further configured to:
determine a first set of positions where the first camera is located when capturing the first set of images and a second set of positions where the second camera is located when capturing the second set of images;
obtain a first set of calibration parameters of the first camera and the first set of light sources for a first position and a second set of calibration parameters for a second position;
obtain a third set of calibration parameters of the second camera and the second set of light sources for a third position and a fourth set of calibration parameters for a fourth position;
compute the first set of parameters based on the first set of calibration parameters, the second set of calibration parameters, and the first set of positions; and
compute the second set of parameters based on the third set of calibration parameters, the fourth set of calibration parameters, and the second set of positions.

22. The electronic device of claim 21, wherein the first position is the first initial position, the second position is the first end position, the third position is the second initial position, and the fourth position is the second end position.

23. The electronic device of claim 17, wherein the control unit is further configured to:
cause a guidance point to be presented at a predetermined position of a display device; and
provide prompt information associated with the guidance point to the user, wherein the prompt information indicates the user to keep gazing at the guidance point.

24. The electronic device of claim 17, wherein the control unit is further configured to:
detect validity of the first set of images and the second set of images; and
in response to both the first set of images and the second set of images being detected as valid, obtain the first set of parameters and the second set of parameters.

25. The electronic device of claim 24, wherein the control unit is further configured to:
detect a left-eye pupil and a right-eye pupil of the user in at least part of the first set of images and at least part of the second set of images respectively according to a pupil detection model;
in response to detecting the left-eye pupil in the at least part of the first set of images, detect a relative position change of a position of the left-eye pupil in the at least part of the first set of images; and
in response to detecting the right-eye pupil in the at least part of the second set of images, detect a relative position change of a position of the right-eye pupil in the at least part of the second set of images.

26. The electronic device of claim 17, wherein the first camera is set on a left-eye lens barrel of a virtual reality device, and the second camera is set on a right-eye lens barrel of the virtual reality device,
wherein a position of the first camera is controlled by controlling a position of the left-eye lens barrel, and
wherein a position of the second camera is controlled by controlling a position of the right-eye lens barrel.

27. The non-transitory computer-readable storage medium of claim 19, wherein the first set of images comprises at least a first image captured at a first time point and a second image captured at a second time point, and the second set of images comprises at least a third image captured at a third time point and a fourth image captured at a fourth time point.

28. The non-transitory computer-readable storage medium of claim 19, wherein obtaining the first set of parameters and the second set of parameters comprises:
determining a first set of positions where the first camera is located when capturing the first set of images and a second set of positions where the second camera is located when capturing the second set of images;
obtaining a first set of calibration parameters of the first camera and the first set of light sources for a first position and a second set of calibration parameters for a second position;
obtaining a third set of calibration parameters of the second camera and the second set of light sources for a third position and a fourth set of calibration parameters for a fourth position;
computing the first set of parameters based on the first set of calibration parameters, the second set of calibration parameters, and the first set of positions; and
computing the second set of parameters based on the third set of calibration parameters, the fourth set of calibration parameters, and the second set of positions.
